(19) United States
(12) Patent Application Publication
(10) Pub. No.: US 2007/0158368 A1
(43) Pub. Date: Jul. 12, 2007

(54) Pump dispenser with trigger

(76) Inventor: Tetsuya Tada, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 10/588,643

(22) PCT Filed: Feb. 7, 2005
(86) PCT No.: PCT/JP05/01746

§ 371 Date: Aug. 4, 2006

(30) Foreign Application Priority Data
Feb. 6, 2004 (JP) 2004-031328

(51) Int. Cl. G01F 11/00

(52) U.S. Cl. 222/321.8

(57) ABSTRACT

To provide a pump dispenser with a trigger, having a simple construction, the number of parts reduced, and remarkably excellent operability. In a pump dispenser (1) which jets liquid in a cylinder (4g) from a nozzle portion (5) when a piston (7) integral with the nozzle portion (5) is pushed down according to grasping of a trigger (4c), the cylinder (4g) is integrally formed inside a barrel portion (4a) disposed along an axial direction of a container and the trigger (4c) is integrally formed on the barrel portion (4a) via a hinge portion (4b). Since the trigger is integrally formed on the cylindrical barrel portion disposed along the axial direction of the container via the hinge portion, a fulcrum for causing the trigger to pivot can be disposed as rearward as possible, so that a large leverage can be taken. Since at least the barrel portion and the trigger are integrally formed from synthetic resin, movement of the pivot fulcrum becomes remarkably accurate.

### TECHNICAL FIELD

The present invention relates to a pump dispenser with a trigger where a piston descends according to triggering.

In particular, the present invention relates to a pump dispenser with a trigger where at least a trigger is integrally formed on a cylindrical barrel portion disposed along an axial direction of a container via a hinge portion.

### BACKGROUND ART

Conventionally, a pump dispenser where a cap attached to an opening of a container is provided with a spray head movable vertically with a piston, and liquid in the container is pressured by causing the spray head to descend to be sprayed from a nozzle portion is known (for example, see Patent Literature 1).

In case of the pump dispenser, liquid is sprayed from the nozzle portion by putting a forefinger (or thumb) on the spray head while grasping the container with a hand and moving the forefinger (or thumb) in a vertical direction.

However, when a discharge amount of the liquid is increased or a discharge rate thereof is accelerated, adjustment must be made by moving a finger in a vertical direction, which results in difficulty of operation.

Therefore, in such a pump dispenser that a spray head is directly pushed with a forefinger (or thumb), for example, there is a case that the finger gets tired and a knuckle is hurt in case of a prolonged activity.

As a pump dispenser which can solve such a problem, one in which a trigger that allows a finger to move laterally is used has been developed (for example, see Patent Literature 2).

The pump dispenser described in the Patent Literature 2 has a grasping portion 100 attached on a cap, as shown in FIG. 6, where a boss portion 100a projecting in a height direction of the pump dispenser is formed on the rear side of the grasping portion 100.

A cover 101 having a trigger 101a is attached on an upper end of this boss portion 100a in a pivoting manner, and a periphery of a disc-like piton 102 is covered with this cover 101.

Further, a protruding portion 101b is formed on the cover 101, and it abuts on the piston 102.

Furthermore, a spray window 101c is formed on the cover 101 so as to allow liquid to be sprayed outward from a nozzle portion 103 provided on an upper portion of the piston 102.

When a finger is put on the trigger 101a while a cap 104 screwed on an opening portion of a container is grasped with a hollow between a thumb and a forefinger, and the trigger 101a is pulled rearward, the protruding portion 101b pivots downward about an upper end of the boss portion 100a serving as a pivot axis P to push down the piston 102.

Therefore, liquid in the container is sprayed from the nozzle portion 103.

Patent Literature 1: JP-A-2003-212261

Patent Literature 2: JP-A-08-196955

### DISCLOSURE OF THE INVENTION

Problem to be solved by the Invention

However, in such a pump dispenser as described in FIG. 6, the grasping portion 100 and the cover 101 are formed as separated members, so that a mechanism forming the pivot axis becomes complicated, which results in increase of the number of parts or the like.

Further, since the pivot axis was positioned inside the cover 101, there was such a drawback that a large leverage cannot be taken.

As above, any conventional pump dispenser is not always satisfied with in terms of operability.

The present invention has been made in view of such a background art for solving the above-described problem of the background art.

That is, an object of the present invention is to provide a pump dispenser with a trigger having a simple construction and the number of parts reduced.

Further, another object of the present invention is to provide a pump dispenser with a trigger having a remarkably excellent operability.

Means for Solving the Problem

As a result of an accumulation of intensive studies with respect to these problem and background, the present inventor has found that the above-described problem can be solved by integrally forming a cylindrical barrel portion disposed along an axial direction of a container and a trigger via a hinge portion, and has completed the present invention on the basis of this finding.

That is, the present invention lies in (1) a trigger type pump dispenser which sprays liquid in a cylinder from a nozzle portion by pushing down a piston integral with the nozzle portion according to grasping of a trigger, wherein the cylinder is integrally formed inside a cylindrical barrel portion disposed along an axial direction of a container, and the trigger is integrated with the barrel portion via a hinge portion.

The present invention lies in (2) a trigger type pump dispenser, wherein a cap to be attached to the container is provided to the lower portion of the barrel portion.

The present invention lies in (3) a trigger type pump dispenser, wherein a blocking piece for blocking pivot of the trigger is pivotally provided on the barrel portion.

The present invention lies in (4) a trigger type pump dispenser, wherein a hook for supporting with a hand is formed on the barrel portion on the side opposite to the trigger.

The present invention lies in (5) a trigger type pump dispenser, wherein a trigger end before being operated is disposed on the same height position as that of the hook.

The present invention lies in (6) a trigger type pump dispenser, wherein the ratio of a distance from the hinge portion to a pushing portion for pushing the piston to a distance from the hinge portion to the trigger end is 1 to 5 or more.

The present invention lies in (7) a trigger type pump dispenser, wherein a difference in height position between the trigger end before being operated (in a state before the trigger is pulled) and the trigger end after being operated is in a range of 25 mm or less.

The present invention lies in (8) a trigger type pump dispenser, wherein a distal end of the nozzle portion is protruded through the upper end portion of the trigger.

The present invention lies in (9) a trigger type pump dispenser, wherein a coved protruding portion which pushes the piston is formed on the trigger and is for pushing down a curved head portion of the curved piston.

The present invention is (10) a trigger type pump dispenser which sprays liquid in a cylinder from a nozzle portion by pushing down a piston integral with the nozzle portion according to grasping of a trigger, wherein the cylinder is integrally formed inside a cylindrical barrel portion disposed along an axial direction of a container, the trigger is integrated with the barrel portion via a hinge portion, a cap to be attached to the container is provided to the lower portion of the barrel portion, a blocking piece for blocking pivot of the trigger is pivotally provided, a hook for supporting with a hand is disposed on the side opposite to the trigger at the same height position level as that of a trigger end before being operated (in a state before the trigger is pulled), a ratio of a distance from the hinge portion to the pushing portion for pushing the piston to a distance from the hinge portion to the trigger end is 1 to 5 or more, and the difference in height position between the trigger end before being operated and the trigger end after being operated is in a range of 25 mm or less.

The present invention lies in (11) a spray container attached with a trigger type pump dispenser according to one of above-described (1) to (10).

A construction which properly combines some of above-described (1) to (11) can be adopted as long as it attains the object of the present invention.

Advantage of the Invention

According to the present invention, since the trigger is integrally formed on the cylindrical barrel portion disposed along an axial direction of the container via the hinge portion, a fulcrum for causing the trigger to pivot can be disposed as rearward as possible, so that a large leverage can be taken.

Since at least the barrel portion and the trigger are integrally formed from synthetic resin, movement of the pivot fulcrum becomes remarkably accurate.

Since the cylinder is integrally formed inside the cylindrical barrel portion disposed along an axial direction of the container, the number of parts or production cost can be reduced.

Since the curved protruding portion for pushing the piston is formed on a portion positioned on upper portion of the piston of the trigger, the trigger can push down a head portion of the piston smoothly.

Therefore, since the piston can be pushed down similarly smoothly by grasping the trigger, adjustment of a discharge amount or a discharge rate of liquid can be performed easily.

### BEST MODE FOR CARRYING OUT THE INVENTION

Best mode for carrying out the present invention will be explained below with reference to the drawings.

FIG. 1 is an appearance view showing a pump dispenser with a trigger according to an embodiment of the present invention.

The pump dispenser 1 of this embodiment has a short-cylindrical cap 2 made from resin.

Many slip-proof grooves 2a are formed on an outer peripheral face of this cap 2 along a thickness direction thereof at fixed intervals.

An introduction hose 3 for sucking up liquid in a container is provided to a lower portion of the cap 2.

On the other hand, a cover member 4 made from synthetic resin is attached to an upper portion of the cap 2.

The cover member 4 includes a cylindrical barrel portion 4a disposed along an axial direction of the container, a hinge portion 4b provided on the side opposite to liquid spray side (the side on which a nozzle portion 5 is provided), and a trigger 4c which is provided on the liquid spray side and is pivotally integrated with the cylindrical barrel portion 4a via the hinge portion 4b.

The hinge portion 4b is formed by bending a portion of the cover member 4 into a small arc shape, and it serves as a fulcrum when the trigger 4c is caused to pivot.

A plate-like hook 4d for supporting a weight of the pump dispenser 1 with a hand is formed to the cover member 4 on the side opposite to the trigger 4c.

When the pump dispenser 1 is grasped, a thumb or a crotch portion between a thumb and a forefinger is placed on a lower portion of the hook 4d, so that this hook 4d supports the pump dispenser 1 to prevent the same from dropping down.

On the other hand, a plate-like blocking piece 4e for blocking pivot of the trigger 4c is pivotally provided on the side opposite to the hook 4d of the cover member 4 via a thin portion.

When the pump dispenser 1 is not used, the blocking piece 4e restricts pivot of the trigger 4c, while, when it is used, it is only necessary to remove restriction of the trigger 4c by causing the blocking piece 4e to pivot downward to be free.

As above, since there is no fear of spraying liquid by pulling the trigger 4c unintentionally when the pump dispenser is not used, it is useful particularly when liquid is toxic substance such as insecticide.

Next, an inner construction of the pump dispenser 1 will be explained with reference to FIG. 2.

FIG. 2 shows a section of the pump dispenser 1 in FIG. 1.

A ring protrusion 4f is formed on the lower end side of the cover member 4, and when the pump dispenser 1 is pushed down from above and the ring protrusion 4f is inserted into the cap 2, the ring protrusion 4f is fitted into the cap 2 while crossing over a catching portion 2b formed on the upper end side of the cap 2.

The trigger 4c is arranged so as to surround the nozzle portion 5, but it includes a notched portion 4i having a fixed width over a fixed length formed on an upper end portion thereof.

Therefore, even if the trigger 4c is caused to pivot, it can avoid the piston 7 because of the notched portion 4i.

A distal end of the nozzle portion is put in a protruding state through an upper end portion of the trigger even before operation of the trigger 4c.

A multistage-shaped cylinder 4g is integrally formed on the cover member 4 inside the cylindrical barrel portion 4a.

A spring 6 is inserted in this cylinder 4g, and the piston 7 positioned in the cylinder is biased upward by the spring 6.

The piston 7 is formed with a piston main body 7a disposed in alignment with the spring 6, and a cylindrical arm portion 7b projecting in a horizontal direction on the upper end side of the piston main body 7a.

A path 7c is formed in the piston main body 7a, and it communicates with a path 7d formed in the arm portion 7b.

Further, a distal end side of this arm portion 7b is fitted in the nozzle portion 5.

The path 7d of the arm portion 7b is further caused to communicate with a spray path 5a formed in the nozzle portion 5.

A head of the piston 7 is formed in a curved shape, and it abuts on a coved protruding portion 4h formed on the back side of the cover member 4.

Since the coved protruding portion 4h has a so-called gentle curved face which has a curvature larger than that of a curved face of the head of the piston 7, force can be transmitted accurately even by pivot of the trigger 4c.

A nozzle cap 5b integrally formed with the nozzle portion 5 is pivotally formed at the distal end of the nozzle portion 5.

To open the nozzle cap 5b, it is only necessary to lift a tab portion 5c of the nozzle cap 5b.

Next, an operation for operating the trigger 4c of the pump dispenser 1 of the embodiment, that is, an operation for causing the trigger to pivot according to pulling thereof will be explained.

FIG. 3 shows a state before the trigger 4c of the pump dispenser 1 is pulled (shown with a dashed line) and a state after it is pulled (shown with a solid line).

When the pump dispenser 1 is operated, that is, the trigger 4c is pulled, a thumb 10 or a crotch portion between the thumb 10 and a forefinger is first placed on the outer peripheral face of the cap below the hook 4d, and for example a forefinger 8 and a middle finger 9 are put on the trigger 4c.

In this case, the middle finger 9 is positioned near a lower end of the trigger 4c.

From this state, the forefinger 8 and the middle finger 9 are pulled in to move the trigger 4c from a position shown with a dashed line to a position shown with a solid line in Figure.

Before operation (in a state before the trigger 4c is pulled), a distal end of the trigger 4c (that is, a trigger end) is at the same height position as that of the hook 4d, but after operation (in a state that the trigger 4c is pulled to the full), the height position of the trigger end becomes lower than that of the hook.

In this case, it is preferable that a difference H in height position between the trigger end before operation and the trigger end after operation is 25 mm or less.

That is because the range of the difference H in height position is a range where a normal grown-up can move his/her fingers smoothly when he/she operates the trigger.

In operation of the trigger, it is assumed that the trigger is used while a thumb (or a crotch portion between a thumb and a forefinger) is placed under the hook.

Now, it has been experimentally validated that, when the difference H is more than 25 mm, it is difficult especially for a child to move his/her fingers smoothly.

As shown in FIG. 4, a ratio (that is, “leverage”) of a distance L1 from the hinge portion 4b (hinge point P) to a pushing point Q where the piston 7 is pushed to a distance L2 from the hinge portion 4b (hinge point P) to the trigger end R is 1 to 5 or more.

By comparison, it is difficult to take such leverage” in a conventional pump dispenser 1 because of its construction.

The leverage of 1 to 5 or more is achieved because of such a construction that such a hinge point P as used in the present invention can be set as rearward as possible, that is, the trigger is integrally formed on the barrel portion via the hinge portion.

Therefore, by setting the difference H in height position regarding the trigger end to above-described 25 mm or less, and setting the leverage to 1 to 5 or more, it becomes more synergistically easy to move fingers.

FIG. 5 shows a section of the pump dispenser 1 after operation (in a state that the trigger 4c has been pulled to the full). (Incidentally, a state that the nozzle cap 5b has been closed is shown).

An angle of the piston 7 changes when the trigger 4c pivots, the protruding portion 4h pushes down the head of the piston, and the piston descends against repulsion of the spring 6.

At this time, even if the trigger 4c pivots downward, the pivot of the trigger is never prevented because of the notched portion 4i.

The nozzle portion 5 is largely exposed as the trigger pivots downward.

Therefore, the exposed nozzle portion 5 can be used as a mark to focus on a position to be sprayed accurately, so that a target becomes easy to aim at.

In the above-described pump dispenser 1 of the embodiment, since the piston 7 is covered with the cover member 4, and the cover member 4 is integrally formed with the cylindrical barrel portion 4a disposed along an axial direction of the container, the hinge portion 4b disposed on the side opposite to the liquid spray side, a trigger 4c which suspends on the liquid spray side and pivots about the hinge portion 4b, and the cylinder 4g, the number of parts, production cost, or the like can be reduced.

Since at least the barrel portion and the trigger are integrally formed from synthetic resin, movement of a pivot fulcrum becomes remarkably, accurate.

Since the trigger is integrally formed on the barrel portion via the hinge portion, the fulcrum for causing the trigger to pivot can be disposed as rearward as possible, so that a large leverage can be taken.

Since the piston can be similarly pushed down smoothly by grasping the trigger firmly, adjustment of a discharge amount or a discharge rate of liquid can be performed easily.

Since the head of the piston 7 is formed in a curved shape, and it is pushed by a coved protruding portion 4h formed on the reverse side of the cover member 4, force for pulling the trigger is transmitted to the piston 7 accurately.

The present invention has been explained above, but it is not limited to the above-described embodiment, and it goes without saying that other various modifications can be performed without departing from the scope of the present invention.

For example, in the above-described embodiment, an example that the hinge portion 4b is formed by forming a portion of the cover member 4 in an arc shape has been explained, but a portion of the cover member bent at an acute angle can be adopted, of course.

The barrel portion, the cylinder, and the trigger are integrally formed, but only the barrel portion and the cylinder can be integrally formed.

### INDUSTRIAL APPLICABILITY

The present invention relates to a pump dispenser with a trigger where a piston descends by triggering, in particular to a pump dispenser with a trigger where at least a trigger is integrally formed on a cylindrical barrel portion disposed along an axial direction of a container via a hinge portion, but the present invention can be applied to another field of a container for jetting as long as the principle of the present invention is employed, and the application field is wide.

### BRIEF DESCRIPTION OF THE DRAWINGS

FIG. 1 is an explanatory view showing a pump dispenser with a trigger according to an embodiment of the present invention;

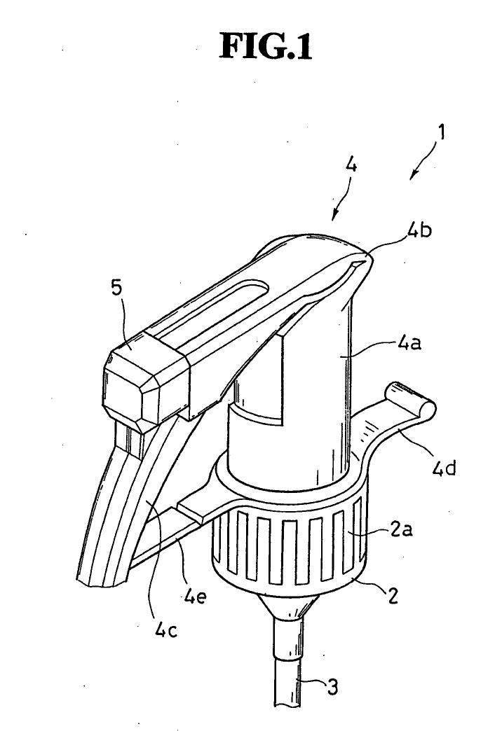

FIG. 2 is a half-sectional view of the pump dispenser in FIG. 1;

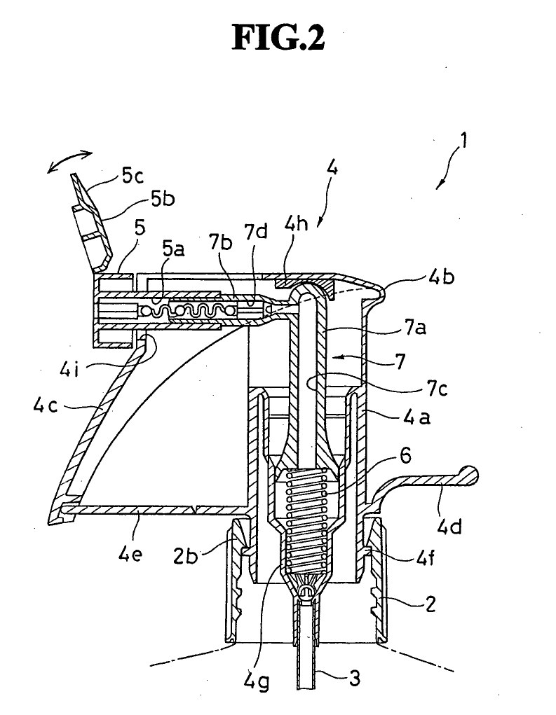

FIG. 3 is an explanatory view showing a state before the trigger is pulled and a state after it is pulled;

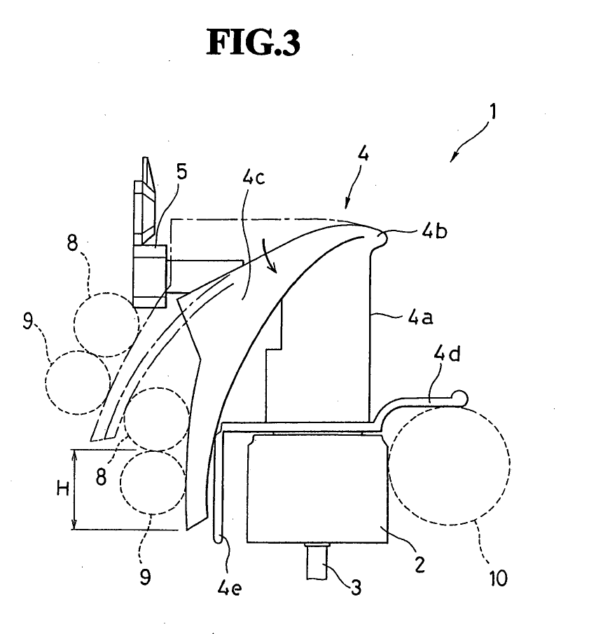

FIG. 4 is an explanatory view showing a distance from a hinge portion to a protruding portion and a distance from the hinge portion to a trigger end;

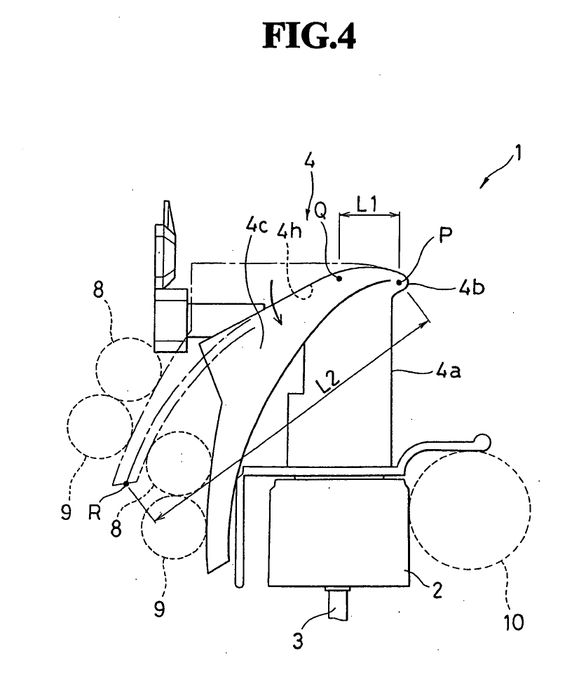

FIG. 5 is a half-sectional view of the pump dispenser showing a state after the trigger is pulled; and

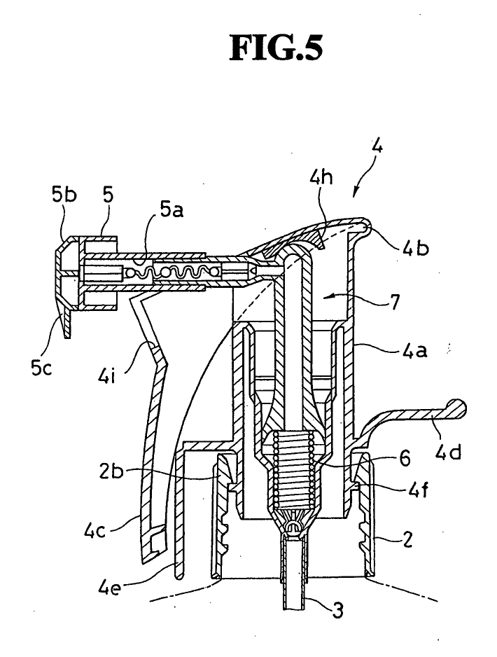

FIG. 6 is an explanatory view showing one example of a conventional pump dispenser with a trigger.

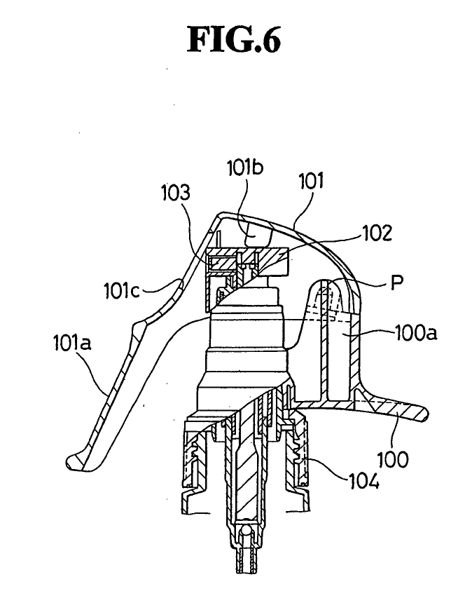

### EXPLANATION OF REFERENCE NUMERALS

1 pump dispenser
2 cap
2a groove
2b catching portion
3 introduction hose
4 cover member
4a barrel portion
4b hinge portion
4c trigger
4d hook
4e blocking piece
4f ring protrusion
4g cylinder
4h protruding portion
4i notched portion
5 nozzle portion
5a liquid spray hole
5b nozzle cap
5c tab portion
6 spring
7 piston
7a piston main body
7b arm portion
7c path
7d path
8 forefinger
9 middle finger
10 thumb
100 grasping portion
100a bass portion
101 cover
101a trigger
101b protruding portion
101c spray window
102 piston
103 nozzle portion
104 cap
P hinge point
Q pushing point
R trigger end

1. A trigger type pump dispenser which sprays liquid in a cylinder from a nozzle portion by pushing down the piston integral with the nozzle portion according to grasping of a trigger, wherein
the cylinder is integrally formed inside a cylindrical barrel portion disposed along an axial direction of a container, and the trigger is integrally formed on the barrel portion via a hinge portion.

2. The trigger type pump dispenser according to claim 1, wherein a cap to be attached to the container is provided to a lower portion of the barrel portion.

3. The trigger type pump dispenser according to claim 2, wherein a blocking piece for blocking pivot of the trigger is pivotally provided on the barrel portion.

4. The trigger type pump dispenser according to claim 2, wherein a hook for supporting the pump dispenser with a hand is formed on the barrel portion on the side opposite to the trigger.

5. The trigger type pump dispenser according to claim 1, wherein a trigger end before operation is disposed at the same height position as that of the hook.

6. The trigger type pump dispenser according to claim 1, wherein the ratio of a distance from the hinge portion to a pushing portion for pushing the piston to a distance from the hinge portion to the trigger end is 1 to 5 or more.

7. The trigger type pump dispenser according to claim 1, wherein a difference in height position between the trigger end before operation (in a state before the trigger is pulled) and the trigger end after operation is in a range of 25 mm or less.

8. The trigger type pump dispenser according to claim 1, wherein a distal end of the nozzle portion is protruded through an upper end portion of the trigger.

9. The trigger type pump dispenser according to claim 1, wherein a coved protruding portion which pushes the piston is formed on the trigger to push down a curved head portion of the curved piston.

10. The trigger type pump dispenser according to claim 1, which sprays liquid in a cylinder from a nozzle portion by pushing down the piston integral with the nozzle portion according to grasping of a trigger, wherein
the cylinder is integrally formed inside a cylindrical barrel portion disposed along an axial direction of a container, the trigger is integrally formed on the barrel portion via the hinge portion, a cap to be attached to the container is provided to the lower portion of the barrel portion, a blocking piece for blocking pivot of the trigger is pivotally provided, a hook for supporting with a hand is disposed on the side opposite to the trigger at the same height position as that of the trigger end before operation (in a state before the trigger is pulled), the ratio of a distance from the hinge portion to a pushing portion for pushing the piston to a distance from the hinge portion to the trigger end is 1 to 5 or more, and a difference in height position between the trigger end before operation and the trigger end after operation is in a range of 25 mm or less.

11. A spray container attached with the trigger type pump dispenser according to claim 1.
